(19) United States
(12) Patent Application Publication
(10) Pub. No.: US 2010/0302785 A1
(43) Pub. Date: Dec. 2, 2010

(54) LED LENS AND ASSEMBLY

(75) Inventor: Huijun ZHOU, Shenzhen (CN)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: BYD COMPANY LIMITED, Shenzhen (CN)

(21) Appl. No.: 12/787,638

(22) Filed: May 26, 2010

(30) Foreign Application Priority Data
May 31, 2009 (CN) 200910107553.6

(51) Int. Cl. F21V 5/04; G02B 17/00

(52) U.S. Cl. 362/311.02; 359/727

(57) ABSTRACT

A lens comprises an incident curved surface and an exit curved surface opposite to the incident curved surface. The incident curved surface and the exit curved surface are configured such that light emitted from a light emitting diode (LED) light source enters the lens through the incident curved surface and incident on the exit curved surface, and is refracted by the exit curved surface. The position of a point on the exit curved surface is represented by z=z₀−\sqrt{r²−(x²+y²)}+ax²+by²+cx²y², where x, y and z are respective coordinates along X, Y and Z axes, and parameters a, b, c, r and z₀ are numbers determining the shape of the exit curved surface. The Z axis coincides with an optical axis of the lens.

### CROSS-REFERENCE TO RELATED APPLICATION

This application claims foreign priority benefits under 35 U.S.C. §119 of Chinese Patent Application Serial No. No.200910107553.6, filed on May 31, 2009, the content of which is incorporated herein by reference in its entirety.

### TECHNICAL FIELD

Exemplary embodiments of the present invention relate to an illumination system, and in particular, relate to a light emitting diode (LED) assembly.

### BACKGROUND

Light emitting diodes (LEDs) have been primarily used in illuminating devices, display panels, decoration lighting systems and similar applications. With development of the LED technology, high-power LED assemblies are now available as an alternative to incandescent bulbs and fluorescent tubes as illumination devices, in view of their energy saving, longer lifespan and simple designs.

Although a high-power LED assembly used as light source may have the above advantages, it may generate disperse and wide angle beams resulting in great loss of output energy. In addition, when a high-power LED assembly is used to illuminate a comparable large area, it may unevenly distribute light. As a result, hot spots or shadows may appear on a target area.

### BRIEF SUMMARY

According to one exemplary embodiment of the invention, a lens comprises an incident curved surface and an exit curved surface opposite to the incident curved surface. The incident curved surface and the exit curved surface are configured such that light emitted from a light emitting diode (LED) light source enters the lens through the incident curved surface and incident on the exit curved surface, and is refracted by the exit curved surface. The position of a point on the exit curved surface is represented by z=z₀−\sqrt{r²−(x²+y²)}+ax²+by²+cx²y², where x, y and z are respective coordinates along X, Y and Z axes, and parameters a, b, c, r and z₀ are numbers determining the shape of the exit curved surface. The Z axis coincides with an optical axis of the lens.

According to another exemplary embodiment of the invention, an assembly comprises a base, a light emitting diode (LED) light source deposed on the base, and a lens. The lens includes an incident curved surface facing toward the light source, and an exit curved surface opposite to the incident curved surface. The lens is configured such that light emitted from the light source enters the lens through the incident curved surface and incident on the exit curved surface, and is refracted by the exit curved surface. The position of a point on the exit curved surface is represented by z=z₀−\sqrt{r²−(x²+y²)}+ax²+by²+cx²y², where x, y and z are respective coordinates along X, Y and Z axes, and parameters a, b, c, r and z₀ are numbers determining the shape of the exit curved surface. The Z axis coincides with an optical axis of the lens.

According to another exemplary embodiment of the invention, an assembly used for a street lamp comprises a base, a light emitting diode (LED) light source deposed on the base, and a lens. The lens includes an incident curved surface facing toward the light source, and an exit curved surface opposite to the incident curved surface. The lens is configured such that light emitted from the light source enters the lens through the incident curved surface and incident on the exit curved surface, and is refracted by the exit curved surface. The position of a point on the exit curved surface is represented by z=z₀−\sqrt{r²−(x²+y²)}+ax²+by²+cx²y², where x, y and z are respective coordinates along X, Y and Z axes, and parameters a, b, c, r and z₀ are numbers determining the shape of the exit curved surface. The Z axis coincides with an optical axis of the lens, and the X axis is parallel to a curb of a street.

### BRIEF DESCRIPTION OF THE DRAWINGS

The foregoing summary, as well as the following detailed description of the invention, will be better understood when read in conjunction with the appended drawings. The embodiments illustrated in the figures of the accompanying drawings herein are by way of example and not by way of limitation. In the drawings:

FIG. 1 illustrates a cross-sectional view of a LED lens according to one exemplary embodiment of the present invention;

FIG. 2 illustrates a bottom view of a LED lens according to one exemplary embodiment of the present invention;

FIG. 3 illustrates a light distribution pattern on XOZ plane according to one exemplary embodiment of the present invention;

FIG. 4 illustrates a light distribution pattern on YOZ plane according to one exemplary embodiment of the present invention; and

FIG. 5 illustrates a cross-sectional view of a LED street lamp according to one exemplary embodiment of the present invention.

### DETAILED DESCRIPTION OF THE PREFERRED

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. In this regard, reference may be made herein to a number of mathematical or numerical expressions or values, and to a number of positions of various components, elements or the like. It should be understood, however, that these expressions, values, positions or the like may refer to absolute or approximate expressions, values or positions, such that exemplary embodiments of the present invention may account for variations that may occur in the multi-channel optical cell, such as those due to engineering tolerances. Like numbers refer to like elements throughout.

FIG. 1 illustrates a cross-sectional view of a LED lens 100 according to one exemplary embodiment of the present invention (“exemplary” as used herein referring to “serving as an example, instance or illustration”). Referring to FIG. 1, the LED lens 100 includes an incident curved surface 102 and an exit curved surface 104 opposite to the incident curved surface 102. Each of the incident curved surface 102 and the exit curved surface 104 may have a central axis (not shown). The incident curved surface 102 may be of any of a number of shapes, such as in the form of a spherical curved surface, an ellipsoidal curved surface, a rectangular curved surface or symmetric irregular curved surface. The lens 100 may have an optical axis A-A. The optical axis A-A locates on, for example, Z axis of a XYZ coordinate system. In this exemplary embodiment, the central axes of the incident curved surface 102 and the exit curved surface 104 coincide with the optical axis A-A, as such both locate on the Z axis. In this manner, the lens may be a coaxial system, thus reducing light loss caused by reflections.

The LED lens 100 may define a space 106 in which an LED light source (not shown) may be placed between a bottom plane 108 of the lens 100 and the incident curved surface 102. The bottom plane 108 may be on Y axis of the XYZ coordinate system. As also shown, a point P is a point on the exit curved surface 104. Its coordinates x, y and z, respectively along the X, Y and Z axes, may satisfy z=z₀−\sqrt{r²−(x²+y²)}+ax²+by²+cx²y². In the preceding, parameters a, b, c, r and z₀ are numbers determining the shape of the exit curved surface 104. In various exemplary embodiments, parameters a, b, c, r and z₀ are real numbers. The parameter z₀ may have a value between 30.0 and 30.1. The parameter r may have a value between 74.0 and 74.1. The parameter a may have a value between 0.01 and 0.02. The parameter b may have value between 0.003 and 0.005. The parameter c may have a value between −0.00001 and −0.00003. In one particular example embodiment, parameter a is about 0.013, parameter z₀ is about 30, parameter r is about 74.07, parameter b is about 0.004, and parameter c is about −0.00002. In another example embodiment, parameter a is about 0.019, parameter z₀ is about 30.05, parameter r is about 74.09, parameter b is about 0.0049, and parameter c is about −0.000029.

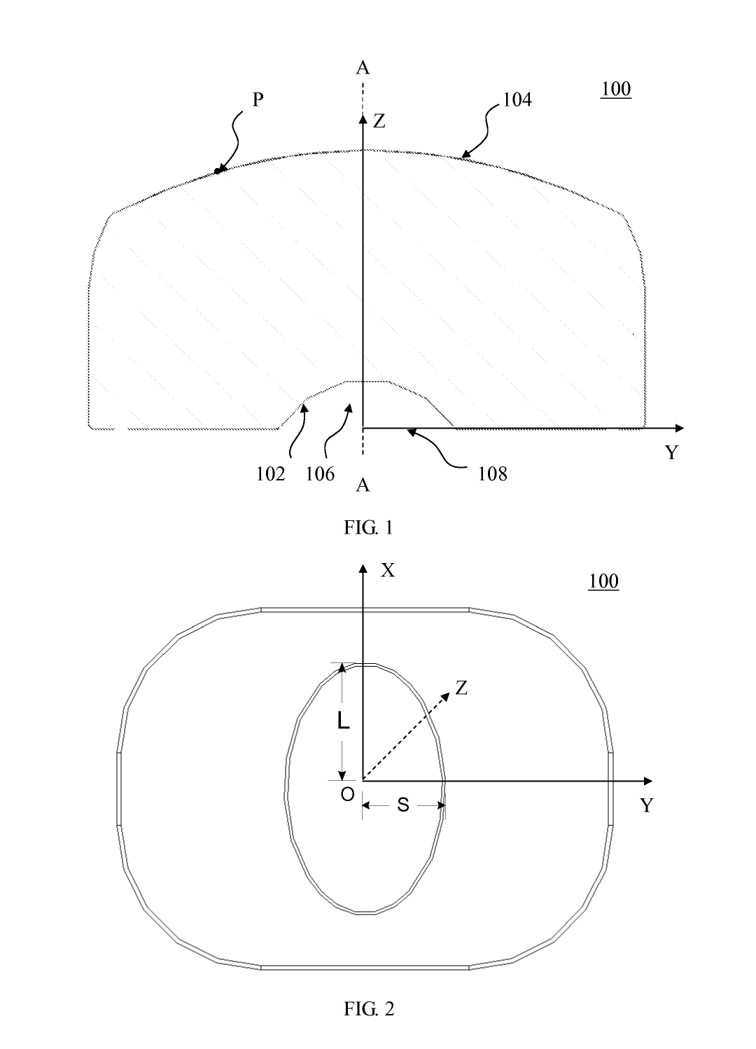

FIG. 2 illustrates a bottom view of the LED lens 100 according to one exemplary embodiment of the present invention. In this exemplary embodiment, the incident curved surface 102 is an ellipsoidal curved surface. Semi-major axis L is along the X axis. Semi-minor axis S is along the Y axis. Origin O of the XYZ coordinate system may be at the center of the ellipse. In some embodiments, the semi-major axis L has a value between 15 mm and 16 mm. In one exemplary embodiment, the semi-major axis L is about 15.5 mm. The material of the LED lens may be a used transparent optical acrylic, which may accordingly reduce the cost of the lens. The optical acrylic may also enhance light transmittance and increase light utilization.

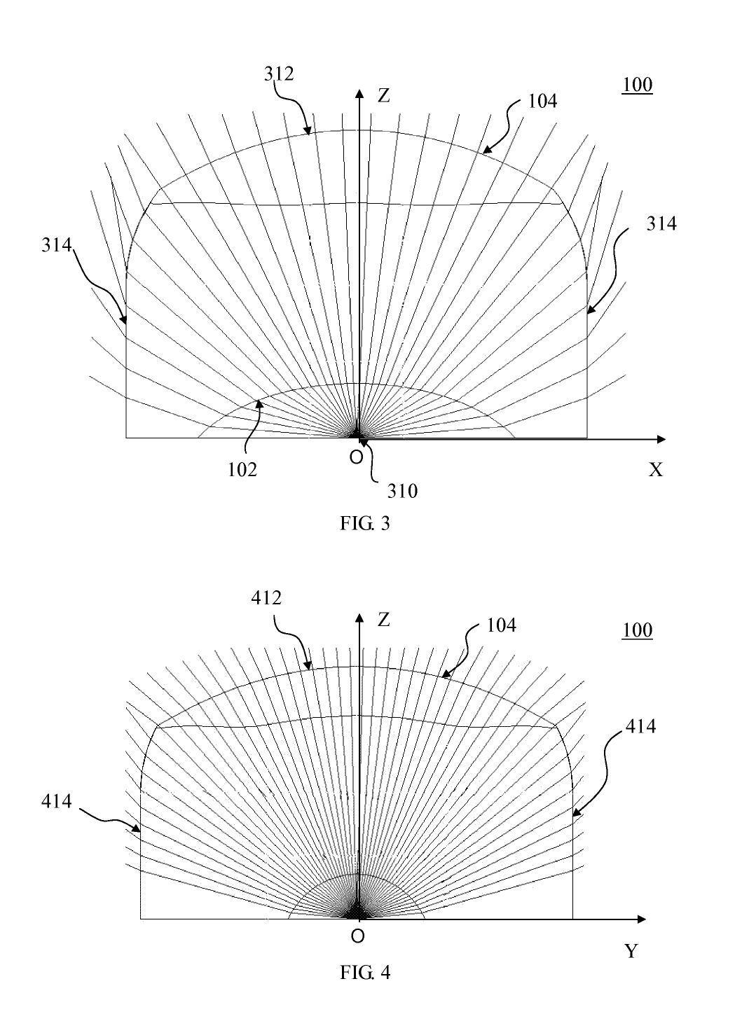

FIG. 3 illustrates a light distribution pattern on the XOZ plane according to one exemplary embodiment of the present invention. An LED light source 310 may be placed at the origin O of the XYZ coordinate system. The focal length of the lens 100 may be about 24 mm. In this exemplary embodiment, rays of light emitted from the light source 310 enter the lens 100 through the incident curved surface 102, and are incident on and refracted by the exit curved surface 104. In this embodiment, the exit curved surface 104 includes a top surface 312 and two side surfaces 314, and the rays of light emitted from side surfaces 314 along with the top surface 312 may illuminate a target area. In one exemplary embodiment, the refractive index of the lens 100 is about 1.49. In this manner, most of the rays of light on the XOZ plane may be refracted by the exit curved surface 104.

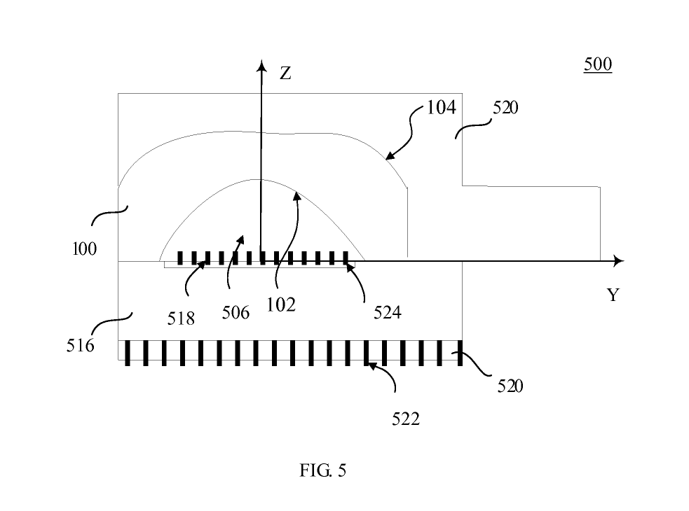

FIG. 4 illustrates a light distribution pattern on YOZ plane according to one exemplary embodiment of the present invention. Similar to the light distribution pattern illustrated in FIG. 3, the rays of light emitted from the side surfaces 414 along with the top surface 412 of the exit curved surface 104 may illuminate a target area. In this embodiment, all of the rays of light on the YOZ plane may be refracted by the exit curved surface 104 and the side surfaces 414. No total internal reflection may occur, thereby enhancing the light energy. The LED may illuminate such as a rectangular area and evenly distribute the rays of light. The length of the rectangular area may be four times the width of the rectangular area in this embodiment.

FIG. 5 illustrates a cross-sectional view of a LED street lamp 500 according to one exemplary embodiment of the present invention. The street lamp 500 includes a base 516, an LED light source 518 disposed on the base 516, and a lens 100 disposed on the base 516. The lens 100 may include an incident curved surface 102 facing toward the light source 518 and an exit curved surface 104 opposite to the incident curved surface 102. The incident curved surface 102 may be an ellipsoidal curved surface. The ellipse's semi-major axis along the axis X may be parallel to the curb of a street. In this manner, the street lamp 500 may illuminate a rectangular area with the length four times the width. Positions of points on the exit curved surface 104 may satisfy z=z₀−\sqrt{r²−(x²+y²)}+ax²+by²+cx²y², which has been described in the descriptions of FIGS. 1 and 2. The rays of light may be evenly distributed due to such a combination of the ellipsoidal incident curved surface 102 and the exit curved surface 104, and accordingly, hot spots or shadows on the target area may be avoided. The LED street lamp 500 may include a housing 520 in which the base 516 and the lens 100 are placed. To transfer thermal energy from the heat source, such as the LED light source 518, to the surrounding area, the housing 520 may include a number of fins 522.

The LED light source 518 may include a plurality of LEDs and may be placed in a space 506 defined between the incident curved surface 102 and the base 516. In some exemplary embodiments, the LED light source 518 may be a LED chip (integrated circuit) module or a LED chip with a single in-line package. In this embodiment, the LED chip module may include a plurality of LED chips (not numbered). The LED light source 518 may include a printed circuit board (PCB) 524 on which the LED chips may be mounted using a method such as surface mount technology (SMT). The PCB 524 may include a driver circuit to efficiently and economically control the LED chips.

It will be appreciated by those skilled in the art that changes could be made to the examples described above without departing from the broad inventive concept. It is understood, therefore, that this invention is not limited to the particular examples disclosed, but it is intended to cover modifications within the spirit and scope of the present invention as defined by the appended claims.

What is claimed is:

1. A lens comprising:
an incident curved surface; and
an exit curved surface opposite to the incident curved surface, wherein the incident curved surface and the exit curved surface are configured such that light emitted from a light emitting diode (LED) light source enters the lens through the incident curved surface and incident on the exit curved surface, and is refracted by the exit curved surface, wherein the position of a point on the exit curved surface is represented by z=z₀−\sqrt{r²−(x²+y²)}+ax²+by²+cx²y², where x, y and z are respective coordinates along X, Y and Z axes, and parameters a, b, c, r and z₀ are numbers determining the shape of the exit curved surface, and wherein the Z axis coincides with an optical axis of the lens.

2. The lens of claim 1, wherein at least one of the incident curved surface or the exit curved surface is symmetric about a central axis along the Z axis.

3. The lens of claim 2, wherein at least one of the incidence curved surface central axis or the exit curved surface central axis coincides with the optical axis of the lens.

4. The lens of claim 1, wherein the incident curved surface comprises one of a spherical curved surface, ellipsoidal curved surface, rectangular curved surface or symmetric irregular curved surface.

5. The lens of claim 1, wherein the incident curved surface comprises an ellipsoidal curved surface, and wherein the semi-major axis of the ellipsoid is about 15.5 mm along the X axis, and the focal length is about 24 mm.

6. The lens of claim 1, wherein parameter z₀ is about 30.0-30.1, parameter r is about 74.0-74.1, parameter a is about 0.01-0.02, parameter b is about 0.003-0.005, parameter c is about −0.00001-−0.00003.

7. The lens of claim 1, wherein the refractive index of the lens is about 1.49.

8. The lens of claim 1, wherein the lens is made from a transparent optical acrylic.

9. An assembly comprising:
a base;
a light emitting diode (LED) light source deposed on the base; and
a lens including:
an incident curved surface facing toward the light source, and
an exit curved surface opposite to the incident curved surface, wherein the lens is configured such that light emitted from the light source enters the lens through the incident curved surface and incident on the exit curved surface, and is refracted by the exit curved surface, wherein the position of a point on the exit curved surface is represented by z=z₀−\sqrt{r²−(x²+y²)}+ax²+by²+cx²y², where x, y and z are respective coordinates along X, Y and Z axes, and parameters a, b, c, r and z₀ are numbers determining the shape of the exit curved surface, and wherein the Z axis coincides with an optical axis of the lens.

10. The assembly of claim 9, wherein at least one of the incident curved surface or the exit curved surface is symmetric about a central axis along the Z axis.

11. The assembly of claim 10, wherein the central axis coincides with the optical axis of the lens.

12. The assembly of claim 9, wherein the incident curved surface comprises one of a spherical curved surface, ellipsoidal curved surface, rectangular curved surface or symmetric irregular curved surface.

13. The assembly of claim 9, wherein the incident curved surface comprises an ellipsoidal curved surface, and wherein the semi-major axis of the ellipsoid is about 15.5 mm along the X axis, and the focal length is about 24 mm.

14. The assembly of claim 9, wherein the refractive index of the lens is about 1.49.

15. An assembly used for a street lamp, comprising:
a base;
a light emitting diode (LED) light source deposed on the base; and
a lens including:
an incident curved surface facing toward the light source, and
an exit curved surface opposite to the incident curved surface, wherein the lens is configured such that light emitted from the light source enters the lens through the incident curved surface and incident on the exit curved surface, and is refracted by the exit curved surface, wherein the position of a point on the exit curved surface is represented by z=z₀−\sqrt{r²−(x²+y²)}+ax²+by²+cx²y², where x, y and z are respective coordinates along X, Y and Z axes, and parameters a, b, c, r and z₀ are numbers determining the shape of the exit curved surface, and wherein the Z axis coincides with an optical axis of the lens, and the X axis is parallel to a curb of a street.

16. The assembly of claim 15, wherein at least one of the incident curved surface or the exit curved surface is symmetric about a central axis along the Z axis.

17. The assembly of claim 15, wherein at least one of the incident curved surface central axis and the exit curved surface central axis coincides with the optical axis of the lens.

18. The assembly of claim 15, wherein the assembly is configured to illuminate a rectangular spot.

19. The assembly of claim 18, wherein the assembly is configured to illuminate a rectangular spot, the rectangular spot having the length four times the width.
